(19) United States
(12) Patent Application Publication
(10) Pub. No.: US 2025/0241317 A1
(43) Pub. Date: Jul. 31, 2025

(54) CONCENTRATED EMULSION OF ESSENTIAL OILS AND APPLICATIONS THEREOF, SUITABLE FOR CONTROLLING AND TREATING DISEASES CAUSED BY PATHOGENS IN PLANTS AND FRUITS

(71) Applicant: PLANTAE LABS SPA, Santiago (CL)

(72) Inventors: Rosa NAVARRO LISBOA, Santiago (CL); Juan Jose ALBARRAN LAMA, Santiago (CL)

(73) Assignee: PLANTAE LABS SPA, Santiago (CL)

(21) Appl. No.: 18/855,164

(22) PCT Filed: Apr. 6, 2023
(86) PCT No.: PCT/CL2023/050032

§ 371 Date: Oct. 8, 2024

Related U.S. Application Data
(60) Provisional application No. 63/328,843, filed on Apr. 8, 2022.

(51) Int. Cl. A01N 65/08; A01N 25/04; A01N 65/10; A01N 65/20; A01N 65/24; A01N 65/26; A01N 65/28; A01N 65/40; A01N 65/44; A01P 3/00

(52) U.S. Cl. CPC A01N 65/08; A01N 25/04; A01N 65/10; A01N 65/20; A01N 65/24; A01N 65/26; A01N 65/28; A01N 65/40; A01N 65/44; A01P 3/00

(57) ABSTRACT

The present invention relates to a concentrated emulsion of essential oils and to applications thereof, suitable for controlling and treating diseases caused by pathogens in plants and fruits.

### FIELD OF THE INVENTION

The present invention refers to a concentrated emulsion of essential oils and its applications, used in the control and treatment of diseases caused by pathogens in plants and fruits.

### BACKGROUND OF THE INVENTION

Emulsions are a system for dispersion of two immiscible liquids that, using an emulsifier and mechanical energy, form a homogeneous system, which, depending on the proportion of dispersed phase and continuous phase, can be classified as oil/water or water/oil emulsions. Emulsifying agents, such as saponins, contain polar and non-polar groups that can reduce the interfacial tension between the oil and water phases, thus allowing both phases to join, and prevent destabilization phenomena, such as: creaming, sedimentation, flocculation, Ostwald ripening and coalescence. Furthermore, depending on the droplet size of the dispersed phase, emulsions can be classified as macroemulsion (0.5 to 100 μm), microemulsion (100 to 1000 nm) and mini or nanoemulsion (10 to 100 nm). In general, due to their versatility in transporting bioactive compounds, mainly of a hydrophobic nature, emulsions are used in various industrial applications, such as: pharmaceuticals, cosmetics and food.

Emulsions are one of the most commonly used systems for transporting essential oils as active agents due to their inherent property of being capable of encapsulating in small droplets, which allow increasing the contact area and thus also protecting them against oxidation factors, such as: light, oxygen and temperature.

Essential oils are of great interest as a natural alternative for conservation/preservation in the food industry, due to their high efficiency as antimicrobial and antioxidant compounds. However, the use of essential oils in food and beverages requires an encapsulation system that allows reducing their high volatility, improving their stability and making them easily dispersible in aqueous matrices. Essential oils contain a complex mixture of aromatic compounds, that, based on their chemical structure, can be classified in general terms as terpenes, terpenoids, phenylpropanoids and others, which are synthesized as secondary metabolites for defense against pathogens, herbivores and insects.

The consumption of fresh fruit is highly valued by consumers due to the nutritional contribution it provides such as fiber, vitamins, etc. The loss of organoleptic and nutritional quality of the fruit, as a result of storage conditions, mechanical damage and metabolic changes, easily causes microbial invasion, resulting in post-harvest fruit disease. For this reason, most fruits must be stored at low temperatures or in controlled environments in order to prolong their useful life and/or fungicides or sanitizers must be used in packing to control pathogens' growth, these being strategies that allow reaching the destination market with a better quality fruit and thus avoiding significant economic losses.

One of the main causes of quality loss is the presence of diseases caused by fungal pathogens: Aspergillus, Alternaria, Fusarium, Penicillium Rhizopus, Botryosphaeria, Colletotrichum, Phytophthora, Ceratocystis, Geotrichum, Phoma, Lasiodiplodia and Macrophomina, Nigrospora, Mucor, Curvalaria, Pestalotia, Phytium, and other agronomically relevant microorganisms.

Fruits such as of avocados, mango, bananas, persimmon, guava, cashew nuts, pitaya, almonds, apples, Arabica coffee, strawberries, papaya, passion fruit, citrus fruits, grapes and others are prone to postharvest diseases caused by pathogens such as Botryosphaeria, Colletotrichum, Geotrichum, Rhizopus, and Phytophthora. Avocado is a crop of great economic importance, which grows in tropical and subtropical areas of the world. The main diseases that manifest in avocados are stem mold or stem rot (Botryosphaeriaceae family), and anthracnose, caused by the fungus Colletotrichum. Many of these pathogens are mainly present in the orchard and infect immature fruits still attached to the plant, and are capable of causing damage during storage. The symptoms of anthracnose include black, circular lesions on the fruit skin that grow rapidly in diameter and become sunken. Many of these diseases are controlled with chemical fungicides (Thiabendazole, Prochloraz) that can act effectively on the pathogen, which are applied as a post-harvest treatment of fruits, but are not applicable in the field. The main problem with the use of these chemical fungicides is resistance, the presence of residues that can pose a threat to human health and the environment.

The present invention refers to a concentrated emulsion based on essential oils, saponin-rich extract as a surfactant, tocopherol as an antioxidant agent and a polymeric matrix. The latter acts as an adherent and stabilizer on the surface of fruits or plants, achieving a prolonged effect and protecting the emulsion from external factors. This concentrated emulsion shows a clear technical advantage in the antifungal activity of emulsions, given mainly by the combination of active ingredients and polymeric matrix, which generates a network that allows the active ingredients to be trapped, and provides greater adherence on the surface of fruits and/or plants, enhancing their antifungal activity over time, becoming equally effective and even better than synthetic products on the market.

### BRIEF DESCRIPTION OF THE INVENTION

The present invention refers to a concentrated emulsion based on essential oils consisting of a mixture of polymers and natural plant extracts as antifungal compounds and natural emulsifiers, oxidative stabilizers and tocopherols as stabilizers of the aqueous and lipid phase, respectively, vegetable essential oil, transported by emulsion technology, and polymers as structuring agents.

### BRIEF DESCRIPTION OF THE DRAWINGS

FIG. 1 shows qualitative EC50 and EC99 results related to in vitro tests performed with different fungi: FIG. 1A: Colletotrichum gloesporoides; FIG. 1B: Penicillium digitatum; FIG. 1C: Botrytis cinerea; FIG. 1D: Botryosphaeria sp.

FIG. 2 shows the content of chlorophyll a, chlorophyll b, chlorophyll a/b and chlorophyll a/carotenoids in plants grown in dishes as a pre-harvest treatment.

FIG. 3 shows the pigment content in T1 plants (Control), T2 (diseased plants) and T3 (T3 applied every 7 days).

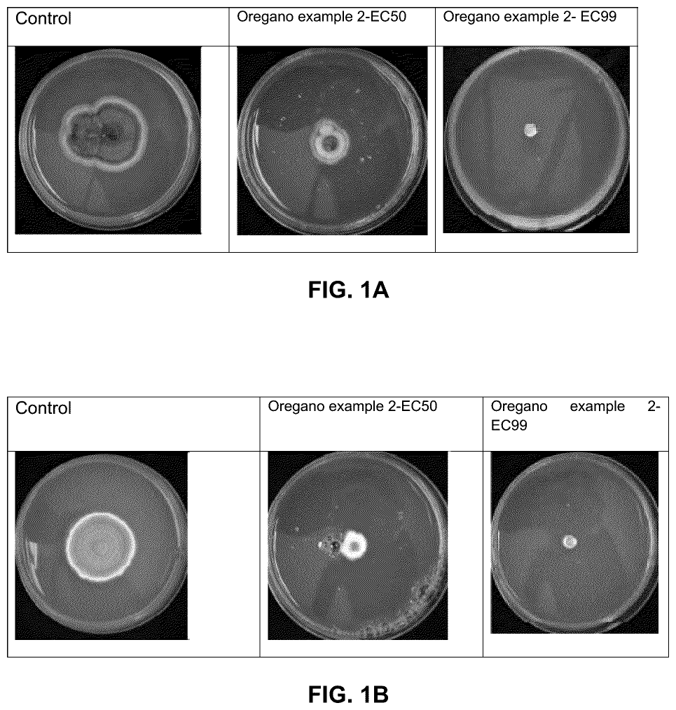

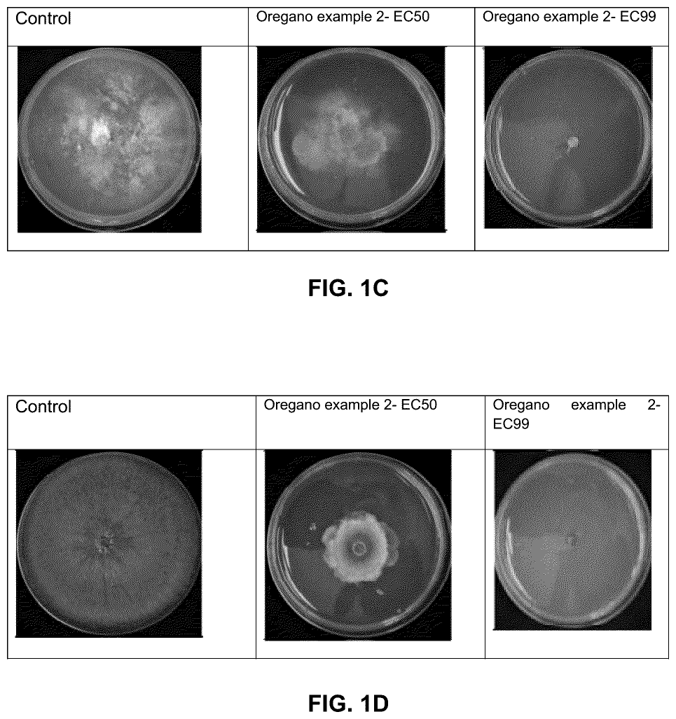

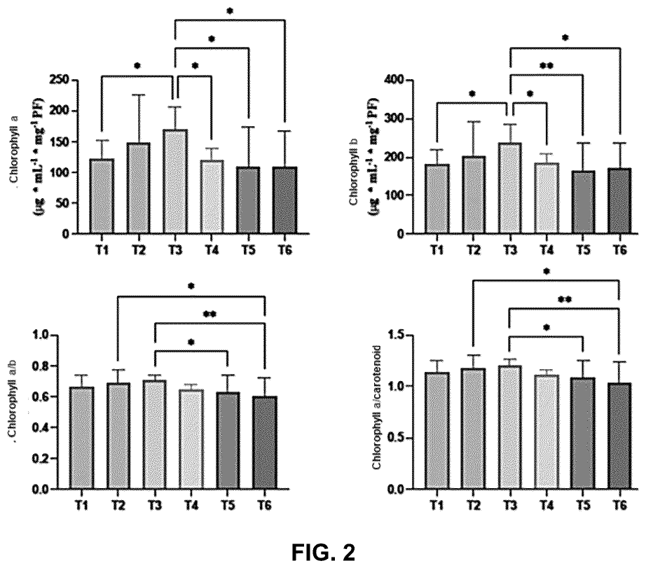

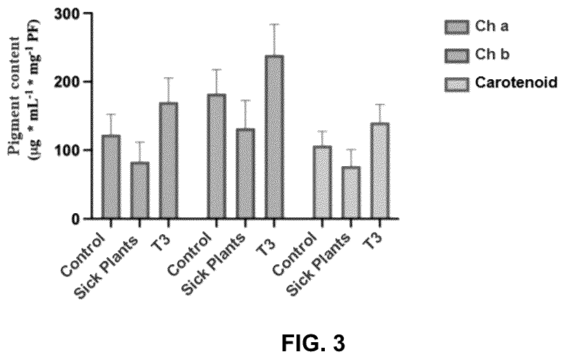

### DETAILED DESCRIPTION OF THE INVENTION

The present invention refers to a concentrated emulsion of essential oils and its applications, used in the control and treatment of diseases caused by pathogens in plants and fruits. In particular, the present invention refers to a concentrated emulsion based on essential oils, triterpenoid/steroidal saponin-rich extract as a surfactant and tocopherol as an antioxidant agent. This is incorporated into a polymeric matrix that acts as an adherent and stabilizer on the surface of fruits or plants.

This concentrated emulsion shows a clear technical advantage in the antifungal activity of emulsions, given mainly by the combination of active ingredients and polymeric matrix, which generates a network that allows the active ingredients to be trapped, and thus the antifungal effect is considerably improved, becoming equally effective and even better than the chemical products on the market.

In one of the embodiments of the present invention, a concentrated emulsion of essential oils is described for controlling diseases caused by pathogens in plants and fruits, which comprises:
between 0.1-30% w/w of a saponin-rich extract;
between 5-45% w/w of a vegetal essential oil;
between 5-20% w/w of a co-solvent agent;
between 0.1-5% w/w of a stabilizing agent;
between 0-10% w/w of a structuring polymer; and
water qs for 100%,

In one of the embodiments of the present invention, the concentrated emulsion is encapsulated, with a particle size between 50-1,000 nm.

In one of the embodiments of the present invention, the saponin-rich extract is selected from soapbark, yucca, quinoa, fenugreek, garlic, fennel, tea, ginseng, alfalfa, oats, fique, chocho, cabuya, black beans, or combinations thereof.

In one of the embodiments of the present invention, the vegetal essential oil is selected from essential oil of oregano, thyme, lemongrass, clove, tea leaves, bayleaf, lemon, cinnamon, neem, savory, copaiba.

In one of the embodiments of the present invention, the co-solvent agent is selected from glycerin, polyols, propylene glycol, PEG 400, glycerin, sorbitol.

In one of the embodiments of the present invention, the stabilizing agent is selected from a mix of tocopherols, rosemary extract, citric acid, ascorbic acid or a mixture thereof.

In one embodiment of the present invention, the structuring polymer is selected from pectin, glycerin, carboxymethylcellulose, modified starch, starch, maltodextrin, agar, chitosan, xanthan gum, guar gum, or combinations thereof.

In one of the embodiments of the present invention, the emulsion comprises an effective amount (between 0.01% and 10% v/v) of said concentrated microemulsion.

In one of the embodiments of the present invention, a process for preparing concentrated emulsions is described, which comprises the following steps:
a) mixing the essential oil, with at least one antioxidant compound, optionally with a vegetable oil and optionally with an emulsifying agent to obtain a lipid phase;
b) adding a high HLB emulsifying agent, a co-surfactant and optionally a water-containing polymer to the mixture of step a) to obtain an aqueous phase;
c) applying shear force to form a pre-emulsified concentrate; and
d) applying high-pressure force to form a low particle size emulsified concentrate comprising values between 50-1,000 nm.

In one of the embodiments of the present invention, a method is described for controlling diseases caused by pathogens in plants and fruits in the pre-harvest period, wherein said method comprises applying an effective amount (between 0.001 L/ha and 10 L/ha) of the coated concentrated microemulsion, which is applied to crop plants such as corn, olives, avocados, mango, bananas, persimmon, guava, cashew nuts, pitaya, almonds, apples, Arabica coffee, strawberries, papaya, passion fruit, citrus fruits, grapes, to be treated, or to the place where they grow, in the pre-harvest period.

In one embodiment of the present invention, a method is described for controlling diseases caused by pathogens in plants and fruits in the post-harvest period, wherein the method comprises applying an effective amount (between 0.01-10% v/v) of the coated concentrated microemulsion. In one embodiment of the present invention, the fruits and/or vegetables can be selected, but are not limited to, avocados, mango, bananas, persimmon, guava, cashew nut, pitaya, almond, apple, Arabica coffee, strawberry, papaya, passion fruit, citrus fruits, grapes, carrot, to be treated, or the place where they grow, in the post-harvest period.

In one embodiment of the present invention, the coated concentrated micro emulsion applied in the method of the present invention has antifungal activity under in vitro and in vivo conditions.

In one of the embodiments of the present invention, infections to be controlled in plant, fruit and/or vegetable crops are microorganisms selected from the genera Colletotrichum gloesporioides, Penicillium digitatum, Botrytis cinerea, Rhizopus stolonifer, Geotrichum candidum, Penicillum expansum, Penicillum italicum, Botryosphaeria, and other agronomically relevant microorganisms.

In one of the embodiments of the present invention, the form of application of the method of the present invention is selected from foliar application, root application, soil application, irrigation application, in-ground application, conventional or electrostatic sprinklers, in-ground sprinklers or combinations thereof.

In one of the embodiments of the present invention, the use of the concentrated emulsion of the present invention is described, which is used in preparing an agrochemical composition to control infections in plant, fruit and/or vegetable crops in pre-harvest and post-harvest.

In one of the embodiments of the present invention, the use of the present invention comprises the application of the concentrated emulsion comprising an effective amount (between 0.001 L/ha and 10 L/ha), which is applied to the plants, fruits and/or vegetables to be treated, or to the place where they grow, in the pre-harvest period.

In one of the embodiments of the present invention, the use of the present invention comprises the application of the concentrated emulsion comprising an effective amount (between 0.01 and 10% v/v), which is applied to the plants, fruits and/or vegetables to be treated, or to the place where they grow, in the post-harvest period.

In one embodiment of the present invention, the use of the present invention comprises the concentrated emulsion composition and has antifungal activity under in vitro and in vivo conditions.

In one of the embodiments of the present invention, the use of the present invention seeks to control infections in plants, which are caused by microorganisms selected from the genera Colletotrichum gloesporioides, Penicillium digitatum, Botrytis cinerea, Rhizopus stolonifer, Geotrichum candidum, Penicillum expansum, Penicillum italicum, Botryosphaeria, and other agronomically relevant microorganisms.

### Examples

The emulsions were prepared by using different essential oils. Among the essential oils studied are: oregano, which is standardized by its carvacrol content guaranteeing a minimum of 80%. Cinnamon, whose active compound is cinnamaldehyde with a minimum of 70% and eugenol 30%, both determined by gas chromatography, Thyme essential oil, whose composition is (thymol 35-55%, Carvacrol 22-35%, P-Cymene 5-12%, Gamma Terpinene 7-22%. Limonene up to 3%, Myrcene up to 3%), and lemon oil, whose main component is Limonene guaranteeing a minimum of 60%. These essential oils are used as active agents that are added to the dispersed phase of the emulsion together with tocopherols (acquired from HSF Biotech company), which contain a mixture of at least 70% tocopherols, within which are alpha (<20%), beta (<10%), gamma (50-70%) and delta tocopherol with <10%.

The main emulsifying agent used is soapbark extract, which is standardized at 6-15% (15-45% bs) of triterpenoid saponins and is mixed with water to form the continuous phase of the emulsion.

Subsequently, different polysaccharides with structural properties such as guar gum, xanthan gum, and pectin are used, which are hydrated with water as a solvent and which subsequently provide adherence to the fruit peel and/or parts of the plant (leaves, stem).

The final product is obtained by mixing 1:1 emulsion:polymeric matrix, which are diluted with water from 0.2% to 3%, depending on the final application (post-harvest and pre-harvest).

These emulsions were characterized according to their particle size, Z potential, pH and solids content prior to their evaluation in in vitro and in vivo systems. As an initial step, to evaluate any adverse impact of the emulsions on fruits, a phytotoxicity test was performed on the peel of different fruits.

Median effective concentration (EC50): To determine median effective concentration (EC50) in parts per million of concentrated emulsions and their components of interest on the mycelial growth of a fungal isolate, tests were performed on different pathogens of interest: Colletotrichum gloesporioides, Penicillium digitatum, Botrytis cinerea, Rhizopus stolonifer, Geotrichum candidum, Penicillum expansum, Penicillum italicum, Botryosphaeria sp. For this purpose, pure cultures of the fungi to be evaluated are prepared, which are shown on Potato Dextrose Agar (PDA) incubated at 24° C. (75.2° F.) for 5 days, with a cycle of 12 hours light/12 hours darkness. These cultures are streaked on PDA and incubated in the dark at 24° C. (75.2° F.) for 48 hours, approximately. Petri dishes with PDA were used for the test, performing three repetitions of the concentration under evaluation. In the center of each dish, a 6 mm PDA peg with fungal mycelium was placed, and the dishes were subsequently incubated at 24° C. (75.2° F.) for 7 days. The evaluation is carried out by measuring the growth diameter of the mycelium of both fungi at the concentrations under study, which were compared with a control solution without product (control solution). The growth diameter in each dish is measured in centimeters (cm) to later calculate the percentage of growth inhibition compared to the values obtained in the corresponding control solution (100% growth).

The most interesting oils, such as oregano and thyme oils, were selected for inoculation tests with avocados and lemons. Within the inoculation tests on avocados (post-harvest), both preventive and curative tests were evaluated, as well as pre-harvest tests on avocado plants. The procedure was as follows:

### Post-Harvest Fruit Test

Preventive treatment: The fruits (avocados) used for product evaluation are harvested green and then stored for 10 days at a temperature of 4-5° C. (39.2 o 41° F.), to achieve subsequent even ripening of the fruits.

Preparation of the fungal culture is done by sowing on Potato Dextrose Agar (PDA) and incubated at 24° C. (75.2° F.) for 7 days, with light and darkness every 12 hours. These cultures are streaked in PDA and incubated until a significant number of conidia are obtained. Conidia are washed from the cultures with sterile distilled water until a suspension of 105 conidia per ml are formed. Prior to application, wounds are made laterally with a sterile pricker on the epidermis on both sides at an equidistant distance. Prior to applying the treatments, the fruits are marked at the place where the wounds are made. Subsequently, treatments are applied by spraying. Finally, they are left to dry at room temperature in the laboratory, and inoculation is carried out with 15 μl of the conidial suspension of the pathogen on the wounds made, and once the inoculum has been absorbed, fruits are left in moist sterile chambers separated from each other.

Once moist chambers are ready, they are moved to a chamber at 20° C. (68° F.) in the dark. They are left there for two weeks, until the fruits begin to ripen. The evaluation is carried out by determining incidence and severity, taking as data the number of inoculations with symptoms. 4 repetitions are evaluated per treatment, where the number of diseased fruits from the total fruits evaluated per repetition (incidence) is recorded, as well as the severity, considering the size of the lesion in each wound according to the following table:

TABLE NO. 1
Scale for measuring the progress of infection
lesions and disease category.

| Note | Progress of the lesion | Category |
|---|---|---|
| 0 | 0 | Healthy |
| 1 | 0.01 to 0.5 cm | Incipient |
| 2 | 0.51 to 1.50 | Moderate |
| 3 | 1.51-2.5 cm | Severe |
| 4 | >2.5 cm (until touching the | Sick |
| | seed) | |

Curative treatment: Fruits used for product evaluation are harvested when green and stored for 15 days at 4° C. (39.2° F.) to achieve even ripening. All fruits were disinfected in sodium hypochlorite at 150 ppm for two minutes and left to dry overnight.

Preparation of the fungal culture is done by sowing on Potato Dextrose Agar (PDA) and incubating at 24° C. (75.2° F.) for 7 days, with light and darkness every 12 hours. Subsequently, streaking is done in PDA and conidia are incubated until a significant number is obtained. These were washed from cultures with sterile distilled water until a suspension of 105 conidia per ml is formed for Colletotrichum. In the case of the Botryosphaeria inoculum, it is obtained by taking 0.6 cm cylinders of mycelium plus Potato Dextrose Agar. After disinfecting the fruits, wounds are made by cutting the stem to commercial size for inoculation with Botryospaheria spp mycelium and covering with adhesive paper to keep the inoculum hydrated on the wound, and thus giving the fungus time to enter the tissue. Wounds for inoculation with Colletotrichum gloesporioides conidia suspension are made with a sterile pricker on the epidermis on both sides at an equidistant distance from each fruit, and are inoculated with 15 uL of the Colletotrichum gloesporioides conidia suspension in each wound, and left to rest for 24 hours to give the pathogen a chance to settle in. The products are applied 24 hours after inoculation using a continuous flow pump, moistening the entire fruit and allowing it to dry at room temperature. Finally, the avocados are stored for 14 days at a room temperature of 20-22° C. (68-71° F.) to finally record severity and incidence.

### Quantification of Incidence and Severity

Treatment incidence is considered as the quotient of the number of fruits that showed symptoms in the inoculated area as per the total number of fruits in each replicate times 100, while the severity is calculated as the diameter of pathogenic growth on day 20 (according to the progress of the inoculated control solution).

TABLE NO. 2
Incidence and Severity Scales for Curative Test

| | Progress of | | Progress of |
|---|---|---|---|
| | the lesion (cm) | Category | the lesion (%) |
| Note | C. gloesporioides | C. gloesporioides | Botryosphaeria sp. |
| 0 | 0 | Healthy | 0 |
| 1 | 0.01 to 0.5 cm | Incipient | 10 |
| 2 | 0.51 to 1.50 | Moderate | 25 |
| 3 | 1.51-2.5 cm | Severe | 50 |
| 4 | >2.5 cm (until | Sick | 75 |
| | touching the seed) | | |
| 5 | | | 100 |

### Tests on Lemons

Preparation of the fungal culture is done by sowing on Potato Dextrose Agar (PDA) and incubating at 24° C. (75.2° F.) for 7 days, with light and darkness every 12 hours. These cultures are streaked in PDA and incubated until a significant number of conidia are obtained. These are washed from the cultures with sterile distilled water until a suspension of 105 conidia per ml is formed. Immediately after both wounds have been made on the lemons, they are inoculated with 15 μL of the Penicillium digitatum conidia suspension, leaving it to rest for 24 hours to give the pathogen a chance to settle in.

The application of the products is carried out the day after inoculation using a continuous flow pump, moistening the entire fruit and allowing it to dry at room temperature.

TABLE NO. 3
P. digitatum severity evaluation scale in inoculated
lemons according to the progress of the lesion.

| Note | Progress of the lesion | Category |
|---|---|---|
| 0 | 0 | Healthy |
| 1 | 0.1 to 1.5 cm | Incipient |
| 2 | 1.6 to 3.5 cm | Moderate |
| 3 | 3.6-5.5 cm | Severe |
| 4 | More than 5.6 cm | Sick |

On the other hand, the efficiency values of the treatments were established with respect to the inoculated control solution treatment, using Abbott's efficiency percentage formula:
Wherein:

$$Porcentaje de eficacia ( Abbott ) = ⌊ 1 - ( \frac{Td}{Cd} ) ⌋ \times 100 = ( \frac{Cd - Td}{Cd} ) \times 100$$

Cd: Incidence of the control solution treatment at the time of evaluation.
Td: Incidence in treatment at the time of evaluation.

### Test on Avocado Plants

The plants come from Toro Canyon clonal rootstocks, pertaining to Hass variety, and are contained in 30 L bags, with a trunk diameter of approximately 2 cm and a height of over 1 meter. These plants were conditioned for acclimatization in greenhouse conditions at INIA, La Platina. The plants were transplanted to 48 L pots, with sterilized leaf soil and watered with drinking water.

Daily temperature and moisture recording was carried out with a temperature and moisture recorder (U12 Temp/RH/2 External Channel Logger, HOBO Onset, Computer Corporation, MA, USA) located on one of the plants, under the canopy, throughout the test. Preparation of the fungal culture is done by sowing on Potato Dextrose Agar (PDA), incubating at 24° C. (75.2° F.) for 7 days, with light and darkness every 12 hours. Agar pegs with 1 cm fungal mycelium are taken from these cultures. Once the acclimatization time is over, the plants are inoculated. Inoculation is carried out in two locations on the main trunk, one close to the apex and another 50-60 centimeters above the crown of the plant. To this effect, tongue-shaped wounds are made using a scalpel, opening the bark slightly and thus placing the peg with the fungus in contact with the tissue, then they are wrapped with wet cotton and sealed with parafilm paper. Once the fungus has settled in, the parafilm is removed. Incidence is quantified as the number of diseased plants relative to the total number of plants, while severity is the number of diseased twigs relative to the total number of twigs in each plant. Chlorophyll and carotenoid production in leaves was also measured.

### Prototype Preparation.

Each emulsion is formulated by mixing the aqueous phase which contains water and Soapbark Extract, while the dispersed phase corresponds to the mixture of essential oil (oregano, or thyme, or lemongrass, or clove, tea leaves or cinnamon, or lemon) and tocopherol. Each phase is mixed at 300 rpm for 5 min. Subsequently, the dispersed phase is slowly added to the aqueous phase, which is maintained at 6000 rpm using high shear homogenization for 10 minutes, resulting in the pre-emulsion. Finally, it is homogenized between 250-500 bar in two steps using a high pressure homogenizer.

In parallel, a polysaccharide matrix composed of different complex sugars, glycerin and water is formulated. To this effect, pectin is mixed with water together with glycerin and left under constant stirring for 12-15 h, to then generate hydration/gelation of pectin by heating at 85° C. (185° F.) for 2 hours in a thermoregulated bath. After two hours, the matrix is cooled to 40° C. (104° F.), where guar gum and xanthan gum are added, which is stirred until completely homogenized (30 min at 200 rpm). Finally, the pH of the polymeric matrix is adjusted between 5-6 for better hydration of the guar gum. In the case of matrices using yucca extract, this is incorporated into the polymeric matrix. For the production of the finished product, emulsion and polymeric matrix are mixed 1:1, respectively.

The emulsions were characterized by determining particle size, polydispersity, and Z potential, using light diffraction methodology by means of a Zetasizer Nano (Malvern, UK). Samples were diluted to a concentration of 0.025%. All quantifications were performed in triplicate.

TABLE NO. 4
Concentrated emulsion formulations.

| | | |
|---|---|---|
| Example 1 | Example 2 | Example 3 |

Emulsion

| | | | |
|---|---|---|---|
| Soapbark Extract | 3 | 7.5 | 12 |
| Essential oil (thyme or cinnamon | 45 | 45 | 45 |
| or tea leaves or oregano or | | | |
| lemongrass, or clove, lemon) | | | |
| Tocopherol | 2.5 | 2.5 | 2.5 |
| Water | 49.5 | 45 | 40.5 |

Polymeric matrix

| | |
|---|---|
| Guar gum | 4 |
| Xanthan gum | 0.8 |
| Pectin | 4 |
| Glycerin | 3 |
| Water | 89.2 |

### Results of Physical Characterization.

TABLE NO. 5
Results of physical characterization of samples size

| | Particle size | Z potential | | |
|---|---|---|---|---|
| Sample | (nm) | (mV) | PdI | Viscosity |
| Oregano- | 602.6 ± 7.5 | −45.5 ± 0.67 | 0.564 ± 0.2 | 939.18 ± 118.12 |
| Example 1 | | | | |
| Oregano- | 567.5 ± 8.89 | −43.4 ± 0.84 | 0.112 ± 0.07 | — |
| Example 2 | | | | |
| Oregano- | 476 ± 11.6 | −39.3 ± 0.56 | 0.078 ± 0.03 | — |
| Example 3 | | | | |
| Tea leaves - | >800 | −30 ± 0.02 | 0.8 ± 0.1 | — |
| Example 1 | | | | |
| Tea leaves - | 526.1 ± 53.7 | −33 ± 0.15 | 0.13 ± 0.05 | — |
| Example 2 | | | | |
| Tea leaves - | 407.8 ± 3.7 | −31 ± 0.06 | 0.17 ± 0.08 | — |
| Example 3 | | | | |
| Cinnamon- | 1998 ± 557 | −33.6 ± 1.12 | 0.122 ± 0.04 | — |
| Example 1 | | | | |
| Cinnamon- | 743.8 ± 102 | −34.3 ± 0.21 | 0.67 ± 0.39 | — |
| Example 2 | | | | |
| Cinnamon- | 443.3 ± 16.3 | −31.7 ± 2.11 | 0.122 ± 0.04 | — |
| Example 3 | | | | |
| Clove - Example 1 | 499.1 ± 60.6 | −32 ± 0.4 | 0.989 ± 0.02 | — |
| Clove-Example 2 | 394.1 ± 19.4 | −33.4 ± 0.7 | 0.387 ± 0.26 | — |
| Clove-Example 3 | 564.7 ± 3.39 | −35.5 ± 1.3 | 0.161 ± 0.03 | — |
| Thyme- | 693.8 ± 8.42 | −47 ± 0.76 | 0.684 ± 0.1 | — |
| Example 1 | | | | |
| Thyme- | 613.5 ± 36.4 | −41.4 ± 0.46 | 0.168 ± 0.08 | — |
| Example 2 | | | | |
| Thyme- | 553 ± 31.6 | −37.6 ± 1.15 | 0.051 ± 0.04 | — |
| Example 3 | | | | |
| Lemongrass - | 2098 ± 815 | −36.9 ± 1.27 | 1 ± 0.9 | — |
| Example 1 | | | | — |
| Lemongrass - | 869.4 ± 8.51 | −36.4 ± 2.53 | 0.16 ± 0.05 | — |
| Example 2 | | | | |
| Lemongrass - | 524.2 ± 7 | −32.2 ± 0.62 | 0.024 ± 0.02 | — |
| Example 3 | | | | |
| Lemon- | 827.5 ± 93.4 | −45.6 ± 0.9 | 0.227 ± 0.1 | — |
| Example 1 | | | | |
| Lemon- | 743.6 ± 48.6 | −46 ± 0.67 | 0.493 ± 0.06 | — |
| Example 2 | | | | |
| Lemon- | 533.8 ± 20.3 | −43.5 ± 2.36 | 0.059 ± 0.04 | — |
| Example 3 | | | | |

### In Vitro Results.

TABLE NO. 6
Effective Concentration 50 and 99 against different pathogens

| | | EC 50 | EC 99 |
|---|---|---|---|
| Product | Pathogen | (ppm) | (ppm) |
| Oregano example 2 | Botrytis cinerea | 20 | 438 |
| | Rhizopus stolonifer | 203 | 771 |
| | Geotrichum candidum | 43 | 527 |
| | Penicillum expansum | 37 | 506 |
| | Penicillum italicum | 31 | 486 |
| | Botrytis cinerea | 43.7 | 262.2 |
| | Botryosphaeria sp. | 66.9 | 125 |
| | Colletotrichum | 113.9 | 704.7 |
| | gloesporoides | | |
| | Penicillum digitatum | 64.0 | 498.4 |
| Thyme example 2 | Colletotrichum | 29.6 | 288.1 |
| | gloesporoides | | |
| | Penicillum digitatum | 15.4 | 241.4 |
| Yucca extract | Colletotrichum | 68.9 | 26346 |
| (10% saponins) | gloesporoides | | |
| Soapbark extract | Colletotrichum | 1340 | 22651862 |
| 6% saponins | gloesporoides | | |

TABLE NO. 7
In vivo results of preventive study.

| | |
|---|---|
| Oregano | Oregano emulsion + |
| example 2 | yucca |

Emulsion

| | | |
|---|---|---|
| Soapbark extract | 7.5 | 7.5 |
| Essential oil (thyme or cinnamon or tea | 45 | 45 |
| leaves or oregano or lemongrass, | | |
| or clove, lemon) | | |
| Tocopherol | 2.5 | 2.5 |
| Water | 45 | 45 |

Polymeric matrix

| | | |
|---|---|---|
| Guar gum | 4 | — |
| Xanthan gum | 0.8 | — |
| Pectin | 4 | 6 |
| Glycerin | 3 | — |
| Yucca extract | — | 50 |
| Water | 89.2 | 44 |

TABLE NO. 8
Results of the preventive study for products containing oregano
at different doses (oregano example 2), compared with field
control solution treatments of Colletotrichum.

| Treatment | Incidence (%) | Abbott's efficiency | Severity |
|---|---|---|---|
| Oregano example 2 | 63.3 b | 21.9 | 1.9 b |
| (1.5% diluted in water) | | | |
| Oregano example 2 | 62.2 b | 23.3 | 1.8 b |
| (3% diluted in water) | | | |
| Inoculated control | 81.1 a | — | 2.4 a |
| solution | | | |
| Field control | 60.3 | — | 2.3 |
| solution | | | |

TABLE NO. 9
Results of the preventive study for products containing
oregano (oregan example 2) compared with field control
solution treatments of Colletotrichum.

| Treatment | Incidence (%) | Severity |
|---|---|---|
| Oregano example 2 (3% | 55.0 c | 1.4 b |
| diluted in water) | | |
| Oregano emulsion + yucca | 62.2 b | 1.8 b |
| (3% diluted in water) | | |
| Inoculated control solution | 81.1 a | 2.4 a |
| Field control solution | 60.3 | 2.3 |

### In Vivo Results of Curative Study in Avocado

TABLE NO. 10
Incidence and severity results of treatments containing Thyme
(Thyme Example 2) for the control of Colletotrichum gloesporioides
and Botryosphaeria sp.

| | Colletotrichum gloesporioides | | Botryosphaeria sp. | |
|---|---|---|---|---|
| Treatment | Incidence (%) | Severity | Incidence (%) | Severity |
| Absolute | 50 | n/a | 0 | nd |
| control | | | | |
| solution | | | | |
| Inoculated | 100b | 2.9b | 100a | 4.6b |
| control | | | | |
| solution | | | | |
| Thyme | 48.4a | 1.2a | 94.8a | 3.3a |
| example 2 | | | | |
| Commercial | 53.5a | 1a | 96a | 3.6a |
| treatment | | | | |

TABLE NO. 11
Formulations of the concentrated oregano emulsion
with different polymeric matrices.

| | |
|---|---|
| Example | Example |
| OREGANO 1 | OREGANO 2 |

Emulsion

| | | |
|---|---|---|
| Soapbark extract | 7.5 | 7.5 |
| Essential oil (oregano) | 45 | 45 |
| Tocopherol | 2.5 | 2.5 |
| Water | 45 | 45 |

Polymeric matrix

| | | |
|---|---|---|
| Guar gum | | 4 |
| Xanthan gum | | 0.8 |
| Pectin | 6 | 4 |
| Glycerin | 4 | 3 |
| Water | 90 | 89.2 |

TABLE NO. 12
Results of the curative study for products
containing oregano in avocados.

| | | Abbott | |
|---|---|---|---|
| | Incidence | Efficiency | |
| Treatment | (%) | (%) | Severity |
| Example oregano 1 (3% diluted | 39.5a | 55.5 | 0.72 b |
| in water) | | | |
| Example oregano 2 (3% diluted | 23.0 a | 74.1 | 0.44 a |
| in water) | | | |
| Commercial control solution | 26.0a | 70.7 | 0.60 ab |
| Inoculated control solution | 88.7b | | 1.94c |

| | | |
|---|---|---|
| Field control solution | 50% | C. gloesporioides |
| | 28% | Botryosphaeria spp. |

### In Vivo Results of Curative Study on Lemons (Postharvest)

TABLE NO. 13
Average incidence percentages, average number of successful
inoculations and average severity of each treatment in the
test with lemons inoculated with Penicillium digitatum.

| | | Abbott | |
|---|---|---|---|
| | Incidence | Efficiency | |
| Treatment | (%) | (%) | Severity |
| Oregano example 2- 300 nm (3% | 77.2b | 13.4 | 2.9b |
| diluted in water) | | | |
| Oregano example 2-700 nm (3% | 71.9b | 19.3 | 2.7b |
| diluted in water) | | | |
| Commercial control solution | 27.6 a | 69.1 | 1.0 to |
| Inoculated control solution | 89.2 c | — | 3.4c |
| Field control solution | 0 | — | — |

### In Vivo Results in Plants (Pre-Harvest)

TABLE NO. 14
Description of treatments, doses and frequency of applications.

| | Treat- | | | No. of |
|---|---|---|---|---|
| Treatment | ment | Dose | | applications |
| Absolute control solution | T1 | — | | 8 (every 7 days) |
| Inoculated control solution | T2 | — | | 8 (every 7 days) |
| Example 2 oregano | T3 | 1.5 | L/ha | 8 (every 7 days) |
| Example 2 oregano | T4 | 1.5 | L/ha | 4 (every 14 days) |
| Commercial control | T5 | 1.5 | L/ha | 4 (every 14 days) |
| solution 1 | | | | |
| Commercial control | T6 | 20-40 | Kg/ha | 3 (once a month) |
| solution 2 | | | | |

TABLE NO. 15
Severity of anthracnose caused by Colletotrichum gloesporioides
in avocado plants treated with different treatments.

| Treatment | Severity (%) |
|---|---|
| Absolute control solution | 0 |
| Inoculated control solution | 59.4a |
| Example 2 oregano | 24.7c |
| Example 2 oregano | 30.0 bc |
| Commercial control solution 1 | 47.1ab |
| commercial control solution 2 | 44.0 abc |

A clear technical advantage is shown in the antifungal activity of emulsions, given mainly by the combination of active ingredients and polymeric matrix, which generates a network that allows active ingredients to be trapped, and provides greater adherence to the surface of fruits and/or plants, enhancing their antifungal activity, becoming equally effective as the products on the market.

Since this invention has been described under the embodiments set forth above, it may seem apparent that other alternatives, modifications or variations would yield the same results; however, we have been able to establish that the subject matter described in this application is fundamental to the success of the invention described herein. Accordingly, the embodiments of the invention are intended to be illustrative, not limiting. Several changes may be made without departing from the spirit and scope of the invention as defined in the following claims.

We claim:

1. A concentrated emulsion of essential oils to control diseases caused by pathogens in plants and fruits, comprising:
between 0.1-30% w/w of a saponin-rich extract;
between 5-45% w/w of a vegetal essential oil;
between 5-20% w/w of a co-solvent agent;
between 0.1-5% w/w of a stabilizing agent;
between 0-10% w/w of a structuring polymer; and
water sq for 100%,
wherein the concentrated emulsion is encapsulated, with particle size between 50-1,000 nm.

2. The emulsion according to claim 1, wherein the saponin-rich extract is selected from soapbark, yucca, quinoa, fenugreek, garlic, fennel, tea, ginseng, alfalfa, oats, fique, chocho, cabuya, black beans, or combinations thereof.

3. The emulsion according to claim 1, wherein the vegetal essential oil is selected from essential oil of oregano, thyme, lemongrass, clove, bay leaves, lemon, cinnamon, neem, savory, copaiba.

4. The emulsion according to claim 1, wherein the co-solvent agent is selected from glycerin, polyols, propylene glycol, PEG 400, glycerin, sorbitol.

5. The emulsion according to claim 1, wherein the stabilizing agent is selected from tocopherol, rosemary extract, citric acid, ascorbic acid or a mixture thereof.

6. The emulsion according to claim 1, wherein the structuring polymer is selected from pectin, carboxymethylcellulose, modified starch, starch, maltodextrin, protein, alginate, guar gum, chitosan, xanthan gum, guar gum, or combinations thereof.

7. The emulsion according to claim 1, comprising an effective amount (between 0.01% v/v and 10% v/v) of said concentrated microemulsion.

8. A process for preparing concentrated emulsions according to claim 1, comprising the following steps:
a) mixing the essential oil, with at least one antioxidant compound, optionally with a vegetable oil and optionally with an emulsifying agent to obtain a lipid phase;
b) adding a high HLB emulsifying agent, a co-surfactant and optionally a water-containing polymer to the mixture of step a) to obtain an aqueous phase;
c) applying shear force to form a pre-emulsified concentrate; and
d) applying high-pressure force to form a low particle size emulsified concentrate between 50-1,000 nm.

9. A method for controlling diseases caused by pathogens in plants and fruits in the pre-harvest period, comprising the application of an effective amount (between 0.001 L/ha and 10 L/ha) of the coated concentrated microemulsion described in claim 1 to the fruit and/or vegetable plants to be treated, or to the place where they grow, in the pre-harvest period.

10. A method for controlling diseases caused by pathogens in plants and fruits in the post-harvest period, comprising the application of an effective amount (between 0.01-10% v/v) of the coated concentrated microemulsion described in claim 1 to the fruits and/or vegetables to be treated, or to the place where they grow, in the post-harvest period.

11. The method according to claim 9, wherein the coated concentrated microemulsion has antifungal activity under in vitro and in vivo conditions.

12. The method according to claim 9, wherein the form of application is selected from foliar application, root application, soil application, irrigation application, in-ground application, conventional or electrostatic sprinklers, in-ground sprinklers or combinations thereof.

13. Use of the concentrated emulsion according to claim 1, wherein it is used to prepare an agrochemical composition to control infections in plant, fruit and/or vegetable crops in pre-harvest and post-harvest.

14. The use of claim 13, wherein the composition comprises an effective amount (between 0.01 L/ha and 10 L/ha) of the coated concentrated microemulsion described in claim 1 to the plants, fruits and/or vegetables to be treated, or to the place where they grow, in the pre-harvest period.

15. The use of claim 13, wherein the composition comprises an effective amount (between 0.1-10% v/v) of the coated concentrated microemulsion described in claim 1 to the plants, fruits and/or vegetables to be treated, or to the place where they grow, in the post-harvest period.

16. The use of claim 13, wherein the composition has antifungal activity under in vitro and in vivo conditions.
